(19) United States
(12) Patent Application Publication
(10) Pub. No.: US 2023/0308300 A1
(43) Pub. Date: Sep. 28, 2023

(54) SYSTEM AND METHOD FOR IMPROVING SECURITY FOR ELECTRONIC DEVICE

(71) Applicant: HODL Tech Private Limited, Singapore (SG)

(72) Inventors: Rohan Hari Agarwal, Delhi (IN); Vipul Saini, Delhi (IN)

(73) Assignee: HODL Tech Private Limited, Singapore (SG)

(21) Appl. No.: 18/127,285

(22) Filed: Mar. 28, 2023

(30) Foreign Application Priority Data
Mar. 28, 2022 (IN) 202211017973

(51) Int. Cl. H04L 9/32; G06F 1/08

(52) U.S. Cl. CPC H04L 9/3271; G06F 1/08; H04L 9/3239

(57) ABSTRACT

A system to continuously search for a solution generated by a potential zombie electronic device, which may produce a hash smaller than or equal to the challenge. As a result, the system continues searching for the solution for a period of time, where the period of time may be dependent on a complexity of the challenge. Further, the generation of the challenge, random salt, and verification of the solution proposed by the system may be performed on a separate, verifier device. The verifier device may contain sensitive data with encrypted communication, and thus, may serve to prevent any potential manipulation on the verifier device. Due to the aforementioned trapdoor property of the proposed system, a locking period is ensured, which facilitates increased security by disrupting a brute force attack vector.

### TECHNICAL FIELD

The present disclosure relates to a system and method for improving security for an electronic device by clock replication.

### BACKGROUND

Background description includes information that may be useful in understanding the present invention. It is not an admission that any of the information provided herein is prior art or relevant to the presently claimed invention, or that any publication specifically or implicitly referenced is prior art.

Electronic devices containing sensitive data may be susceptible to attack by brute force in order to gain access to the sensitive data. Conventional techniques to prevent brute force attack involves use of third-party beneficiaries, deletion of the sensitive data, or other techniques which may be susceptible to glitching attacks.

There is therefore a requirement for a technique to successfully defend against a brute force attack that is reliable, and which does not result in loss of data.

### SUMMARY

Embodiments of this application provides a system and method for improving security for an electronic device by clock replication.

The invention addresses the problem of replicating clock on a passive electronic device whose state may have been compromised, due to which timer based clock may not be reliable. The proposed method includes an external verifier device for ensuring the clock mechanism and issues a cryptographic challenge requiring the compromised device to compute a preimage. This ensures a delay with application in disrupting brute force attack.

The present invention utilizes the trapdoor property of commonly known hashing algorithms (e.g., Secure Hash Algorithm 2 (sha2)) in replicating clock for a computing device. A verification device is provided that continuously search the solution which shall produce the hash smaller than or equal to the challenge thus searching for the solution for an expected time period based on the difficulty of challenge. Furthermore, the generation of challenge, random salt and verification of solution shall be performed on separate passive verifier containing sensitive data with encrypted communication thus mitigating any potential manipulation on device. Legacy mechanisms, for example, adding a static state device counter based on clock are susceptible to be bypassed by on device manipulation (glitching). Due to the aforementioned trapdoor property, the mechanism ensures a locking period and increased security by disrupting a brute force attack vector.

Given a passive electronic device and an independent verifier containing sensitive data, wherein device accesses the data in verifier after unlocking with PIN, the goal is run clock on device for a certain period to ensure delay in an attempted brute force attack assuming device state is manipulated. Furthermore, unlocking of verifier is performed without third party intervention.

Accordingly, in an aspect, to run clock and ensure delay on a passive electronic unreliable device, the external verifier issues a challenge with a randomized salt to device. The device, thereon, starts to compute the solution which when hashed along with salt is less than or equal to the challenge. The time to compute the hash is F(d, h) where d is the difficult, h is hashrate with F(d, h) dx and F(d, h) ⅟hy . The expected time required to compute the challenge being E = d/h. Thus, the difficulty of challenge can be adjusted based on hash rate of device. Eg., for difficulty of 2160, ASIC miner with 14 TH/s shall require an expected time of approx. 3.3 * 10 25 years. The device could record the progress in permanent storage and continue later in scenarios like power down.

The procedure to find a preimage resulting in a hash of specific is an unbounded problem. Thus, the solution shall be computed as an incremental nonce with verifiability in O(c) where c being the hash bitcount. Once the solution is generated, the device shares it to the external verifier which independently verifies if the hash (random salt, solution) matches the criteria for difficulty.

In event of loss of primary device, the verifier could be operated on another device to continue to solve the challenge by fetching the state in the passive verifier.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates a schematic block diagram of a system for improving security for an electronic device, according to an embodiment of the present disclosure; and

FIG. 2 illustrates an exemplary process diagram for a method for improving security for an electronic device, according to an embodiment of the present disclosure.

FIG. 3 illustrates an exemplary flowchart of method for avoiding a clock replication in a potential zombie electronic device; and

FIG. 4 illustrates an exemplary system for avoiding a clock replication in a potential zombie electronic device, according to an embodiment of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

For the understanding of the below description, a “potential zombie electronic device” is a zombie i.e., a computer connected to the Internet that has been compromised by a hacker via a computer virus, computer worm, or trojan horse program and can be used to perform malicious tasks under the remote direction of the hacker. Zombie computers often coordinate together in a botnet controlled by the hacker, and are used for activities such as spreading e-mail spam and launching distributed denial-of-service attacks (DDoS attacks) against web servers. Most victims are unaware that their computers have become zombies.

The present disclosure relates to a system for improving security for an electronic device by clock replication. The system may be used to protect the electronic device against a brute force attack.

The present disclosure provides a system to address a problem of replicating a clock on an electronic device whose state may have been compromised. As a result of the compromised state of the electronic device, a timer-based clock may not be reliable. To overcome this problem, the proposed system includes an external verifier device for ensuring the clock mechanism and issues a cryptographic challenge requiring the compromised device to compute a preimage. This ensures a delay, which may facilitate disrupting a brute force attack.

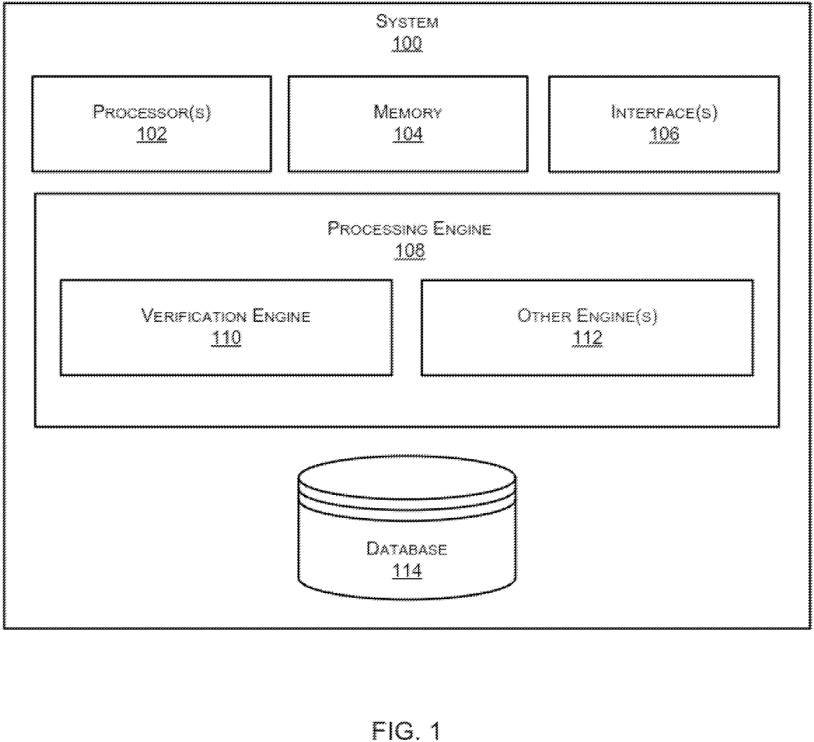

FIG. 1 illustrates a schematic block diagram of a system 100 for improving security for an electronic device (not shown), according to an embodiment of the present disclosure. The system 100 may include the electronic device that has been compromised. The system 100 may utilize a trapdoor property of commonly known hashing algorithms (e.g., sha2) in replicating clock for the electronic device. The system 100 is configured to continuously search for a solution, which may produce a hash that is either smaller than or greater than the challenge. As a result, the system 100 is configured to continue searching for the solution for a period of time, where the period of time may be dependent on a complexity of the challenge. For instance, for a challenge with a high degree of complexity, the system 100 may take a longer period of time searching for a solution.

Further, the generation of the challenge, random salt, and verification of the solution proposed by the system 100 may be performed on a separate, verifier device (not shown). The verifier device may contain sensitive data with encrypted communication, and thus, may serve to prevent any potential manipulation on the verifier device.

Generally, legacy mechanisms, such as adding a static state device counter based on clock are susceptible to be bypassed by on device manipulation (glitching). Due to the aforementioned trapdoor property of the proposed system 100, a locking period is ensured, which facilitates increased security by disrupting a brute force attack vector.

The system 100 includes a processor 102. The processor 102 may include a processing engine 108, which may further include a verification engine 110, and other engines 112. The processor 102 may be communicably coupled with a memory 104. The memory 104 may store instructions, which when executed by the processor 102 may cause the system 100 to perform the steps involved in improving security for the electronic device. The processor 102 may be implemented as one or more microprocessors, microcomputers, microcontrollers, digital signal processors, central processing units, logic circuitries, and/or any devices that process data based on operational instructions. Among other capabilities, the processor 102 may be configured to fetch and execute computer-readable instructions stored in the memory 104 communicably coupled with the system 100 for performing tasks such as receiving a challenge from the verifier device, searching for a solution to the challenge, and/or any other functions. Any reference to a task in the present disclosure may refer to an operation being or that may be performed on data. The memory 104 may be configured to store one or more computer-readable instructions or routines in a non-transitory computer readable storage medium for improving security for the electronic device. In some embodiments, the instructions or routines may be fetched and executed to create or share data packets over a network service. The memory 104 may include any non-transitory storage device including, for example, volatile memory such as RAM, or non-volatile memory such as EPROM, flash memory, and the like. In some embodiments, the system 100 may include interfaces 106. The interfaces 106 may include a variety of interfaces, for example, interfaces for data input and output devices, referred to as I/O devices, storage devices, and the like. The interfaces 106 may facilitate communication of the system 100 with other components of the system 100. The interfaces 106 may also provide a communication pathway for one or more components of the system 100. Examples of such components include, but are not limited to, the processing engine 108 and the database 114.

The processing engine 108 may be implemented as a combination of hardware and programming for example, programmable instructions to implement one or more functionalities of the processing engine 108. In examples described herein, such combinations of hardware and programming may be implemented in several different ways. For example, the programming for the processing engine 108 may be processor executable instructions stored on a non-transitory machine-readable storage medium and the hardware for the processing engine 108 may comprise a processing resource for example, one or more processors, to execute such instructions. In the present examples, the machine-readable storage medium may store instructions that, when executed by the processing resource, implement the processing engine 108. In such examples, the system 100 may include the machine-readable storage medium storing the instructions and the processing resource to execute the instructions, or the machine-readable storage medium may be separate but accessible to the system 100 and the processing resource. In other examples, the processing engine 108 may be implemented by electronic circuitry.

The processing engine 108 may include one or more engines such as the verification engine 110, and other engines 112. The verification engine 110 may facilitate that system 100 to receive the challenge from the external device. Further, the verification engine 110 may facilitate the system 100 to search for a solution to the challenge.

In order to run clock and ensure delay on the electronic device, the verifier device issues a challenge with a randomized salt to the system 100. The system receives the challenge and begins to compute the solution, which when hashed along with salt is required to be less than or equal to the challenge. The time to compute the hash is F (d, h) where d is the difficulty level, and h is hash rate wherein, F (d, h) d^{x} and F (d, h) ⅟h^{y}. The expected time required to compute the challenge is E = d/h. Thus, the difficulty level of the challenge can be adjusted based on hash rate of the system 100.

For example, for a difficulty level of 2¹⁶⁰, ASIC miner with 14 TH/s shall require an expected time of about 3.3*10²⁵ years to compute the challenge. The system 100 may record the progress in a permanent storage and resume the computation in cases where there is a disruption to the computation, such as during power breaks.

The procedure to find a preimage resulting in a hash of specific is an unbounded problem. Thus, the solution shall be computed as an incremental nonce with verifiability in O(c) where c is the hash bit count. Once the solution is generated, the system 100 shares it with the verifier device, which independently verifies if the hash (random salt, solution) matches the criteria for the difficulty level.

In event of loss of the electronic device, the verifier device could be operated on another electronic device to continue to compute the challenge by fetching the state in the verifier device.

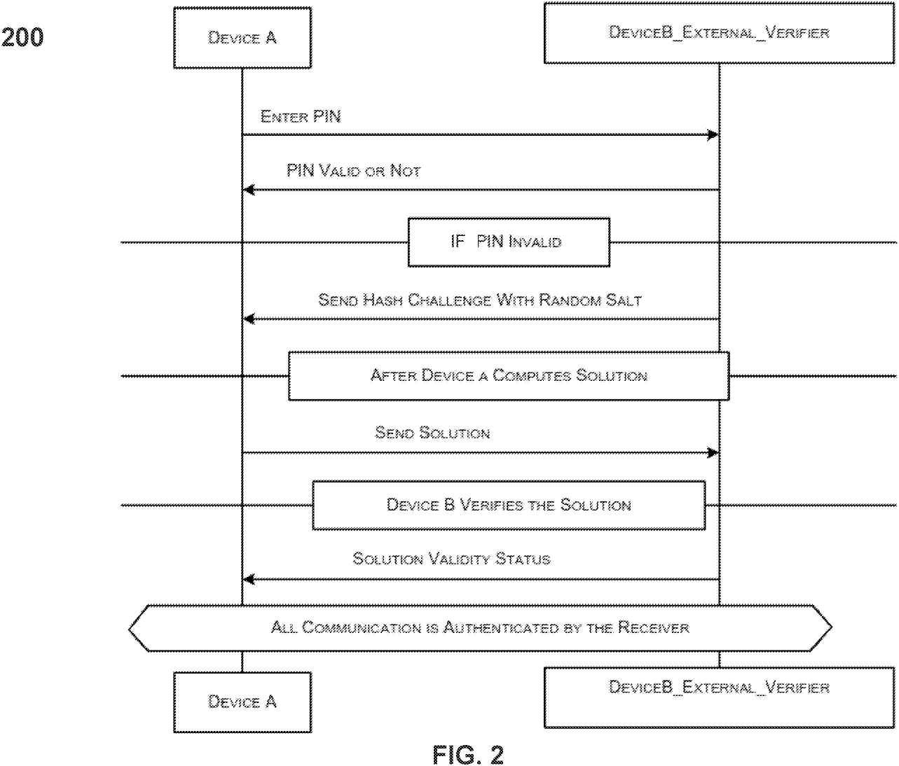

FIG. 2 illustrates an exemplary process diagram for a method 200 for improving security for an electronic device, according to an embodiment of the present disclosure. The method 200 may be implemented in order to protect an external electronic device (Device A) from a brute force attack by using an external verifier device (Device B). In order to access the contents of Device A, a pin or passcode may first be entered, which may be verified by the Device B.

The method 200 may be implemented when the entered pin or passcode is determined to be invalid. An invalid pin may indicate an attempted attack to gain access to the Device A.

The Device B may then issue a challenge to the Device A with a randomized salt in order to run clock and ensure delay on the Device A. The device A may begin to compute the solution. Once the solution is computed, the solution is received by the Device B and is verified therein. Until such time that the solution is verified by the Device B, the delay is ensured on the Device B.

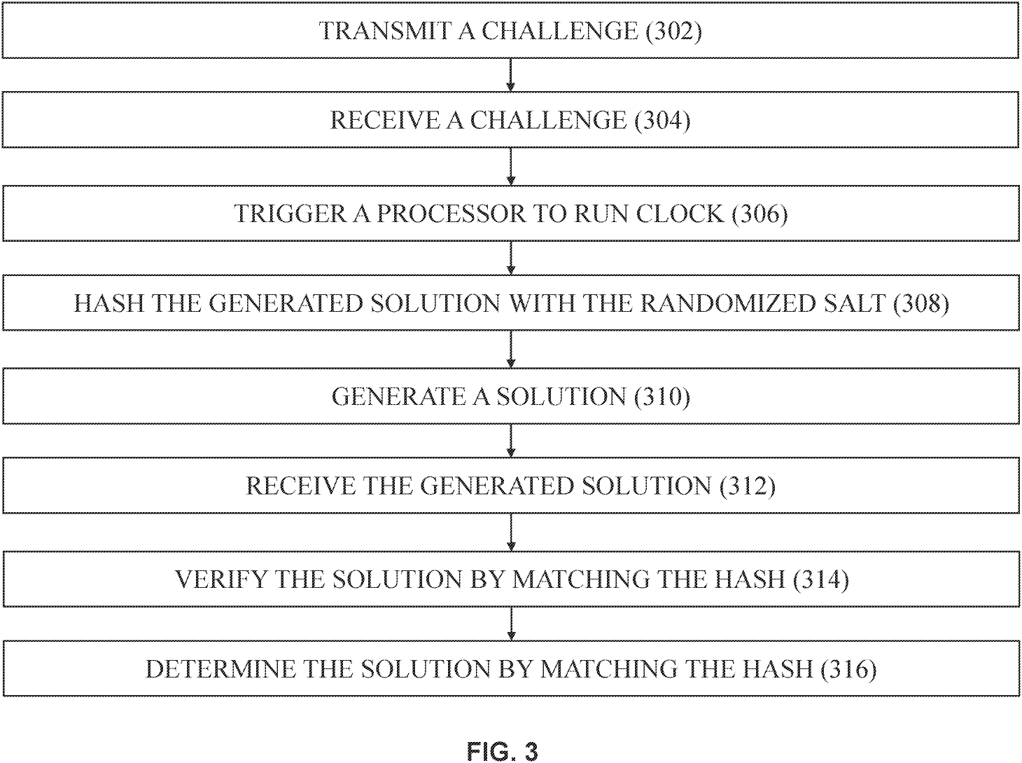

FIG. 3 illustrates an exemplary flowchart of method for avoiding a clock replication in a potential zombie electronic device.

In an embodiment, the method for avoiding a clock replication in a potential zombie electronic device is performed by a verification device.

At step 302, a challenge with a randomized salt is transmitted by a processor of a verification device to the potential zombie electronic device.

At step 312, in response to the receipt of the challenge with the randomized salt, the verification device receives a solution generated by the potential zombie electronic device, wherein the solution is generated in the form of a hash and by utilizing a solution generation time.

At step 314, the solution is verified by verification device by matching the hash and the utilized solution generation time with one or more pre-determined criterions associated with a difficulty level of the challenge.

At step 316, the potential zombie electronic device being a zombie electronic device or not is determined by verification device based on the verification.

In an exemplary embodiment, the randomized salt in the challenge triggers the potential zombie electronic device to run a clock time therein and ensure delay in the clock timing thereof.

In an exemplary embodiment, the challenge is a cryptographic challenge.

In an exemplary embodiment, the solution is a preimage.

In an exemplary embodiment, the challenge is a cryptographic challenge and the solution is a preimage associated with the cryptographic challenge.

In an exemplary embodiment, the hash is a value that is smaller than the challenge; or the hash is a value that is greater than the challenge; or the hash is a value that is equal the challenge.

In an exemplary embodiment, the generated solution is hashed with the randomized salt to generate the utilized solution generation time.

In an exemplary embodiment, if the utilized solution generation time is a time less than or equal to a time required is determined for generating the challenge.

In another embodiment, a method for avoiding a clock replication in a potential zombie electronic device is performed by a system (400).

At step 302, a challenge with a randomized salt is transmitted by a processor of a verification device to the potential zombie electronic device.

At step 304, the challenge is received by a processor of the potential zombie electronic device.

At step 306, a processor of the potential zombie electronic device is triggered by the received randomized salt and the received challenge to run a clock time therein and ensure delay in the clock timing thereof.

At step 308, the generated solution is hashed by the processor of the verification device with the randomized salt to generate the utilized solution generation time.

At step 310, a solution is generated by the processor of the verification device to the received challenge and transmitting the solution to the verification device.

At step 312, the generated solution is received by the generated solution. The solution is generated in the form of a hash and by utilizing a solution generation time

At step 314, the solution is verified by the processor of the verification device by matching the hash and the utilized solution generation time with one or more pre-determined criterions associated with a difficulty level of the challenge

At step 316, the potential zombie electronic device being a zombie electronic device or not is determined by the processor of the verification device based on the verification.

In an exemplary embodiment, the solution is verified by determining if the utilized solution generation time is a time less than or equal to a time required for generating the challenge.

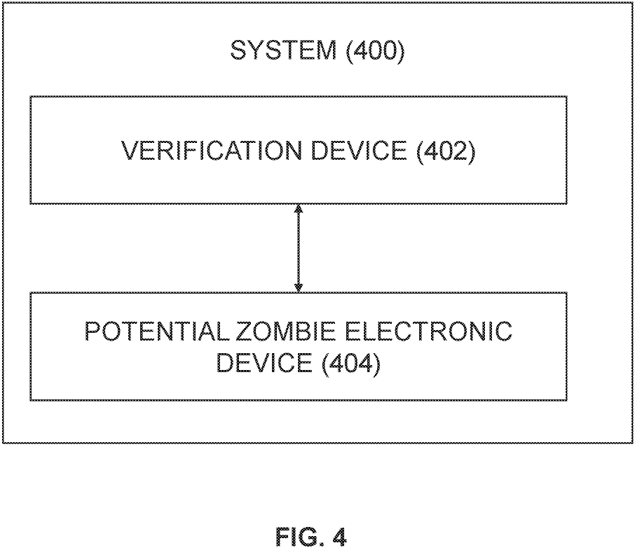

FIG. 4 illustrates an exemplary system for avoiding a clock replication in a potential zombie electronic device, according to an embodiment of the present disclosure.

In an embodiment, a verification device (402) to avoid a clock replication in a potential zombie electronic device is disclosed. The verification device (402) includes a processor. The processor is configured to transmit a challenge with a randomized salt to the potential zombie electronic device, the challenge is a cryptographic challenge; receive in response to the receipt of the challenge with the randomized salt, a solution generated by the potential zombie electronic device, wherein the solution is generated in the form of a hash and by utilizing a solution generation time, and wherein the solution is a preimage associated with the cryptographic challenge; verify the solution by matching the hash and the utilized solution generation time with one or more pre-determined criterions associated with a difficulty level of the challenge, wherein the hash is a value that is smaller than the challenge; or the hash is a value that is greater than the challenge; or the hash is a value that is equal the challenge; and determine the potential zombie electronic device being a zombie electronic device or not based on the verification.

In another embodiment, system (400) to avoid a clock replication in a potential zombie electronic device is disclosed. The system includes a verification device (402) communicably coupled to the potential zombie electronic device (404). The verification device having a processor configured to: transmit a challenge with a randomized salt to the potential zombie electronic device; receive, by a processor of the potential zombie electronic device, the challenge; trigger, by the received randomized salt and the received challenge, a processor of the potential zombie electronic device to run a clock time therein and ensure delay in the clock timing thereof; hash, by the processor of the potential zombie electronic device, the generated solution with the randomized salt to generate the utilized solution generation time; generate, by the processor of the potential zombie electronic device, a solution to the received challenge and transmitting the solution to the verification device; receive the generated solution, wherein the solution is generated in the form of a hash and by utilizing a solution generation time; verify the solution by matching the hash and the utilized solution generation time with one or more pre-determined criterions associated with a difficulty level of the challenge; determine the potential zombie electronic device being a zombie electronic device or not based on the verification.

A person skilled in the art may clearly understand that, for the purpose of convenient and brief description, for detailed working processes of the foregoing system, apparatuses, and units, refer to corresponding processes in the foregoing method embodiments. Details are not described herein again.

An embodiment of this application further provides a computer-readable storage medium storing one or more computer-executable instructions. When the computer-executable instructions are executed by a processor, the processor performs the method according to any specific implementation of the foregoing method embodiments.

An embodiment of this application further provides a computer program product storing one or more computer-executable instructions. When the computer-executable instructions are executed by a processor, the processor performs the method according to any specific implementation of the foregoing method embodiments.

This application further provides a chip system. The chip system includes a processor. The processor may include a baseband processor (BP, baseband processor). For example, the processor may further include an application processor (AP, application processor). The processor is configured to support the communication apparatus to implement a function in any specific implementation of the foregoing method embodiments. In a specific design, the chip system may further include a memory. The memory is configured to store necessary program instructions and data. The chip system may include a chip, or may include a chip and another discrete component.

In the several embodiments provided in this application, it should be understood that the disclosed system, apparatus, and method may be implemented in other manners. For example, the described apparatus embodiments are merely examples. For example, division into units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

Units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and is sold or used as an independent product, the integrated unit may be stored in a computer-readable storage medium. Based on such an understanding, the technical solutions of this application essentially, or the part contributing to the current technology, or all or some of the technical solutions may be implemented in the form of a software product. The computer software product is stored in a storage medium and includes several instructions for instructing a computer device (which may be a personal computer, a server, or a network device) to perform all or some of the steps of the methods described in the embodiments of this application. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C ....and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

What is claimed is:

1. A method for avoiding a clock replication in a potential zombie electronic device, the method comprising:
transmitting, by a processor of a verification device, a challenge with a randomized salt to the potential zombie electronic device;
receiving, by the processor, in response to the receipt of the challenge with the randomized salt, a solution generated by the potential zombie electronic device, wherein the solution is generated in the form of a hash and by utilizing a solution generation time;
verifying, by the processor, the solution by matching the hash and the utilized solution generation time with one or more pre-determined criterions associated with a difficulty level of the challenge; and
determining, by the processor, the potential zombie electronic device being a zombie electronic device or not based on the verification.

2. The method as claimed in claim 1, wherein the method includes: triggering, by the randomized salt in the challenge, the potential zombie electronic device to run a clock time therein and ensure delay in the clock timing thereof.

3. The method as claimed in claim 1, wherein the challenge is a cryptographic challenge.

4. The method as claimed in claim 1, wherein the solution is a preimage.

5. The method as claimed in claim 1, wherein the challenge is a cryptographic challenge and the solution is a preimage associated with the cryptographic challenge.

6. The method as claimed in claim 1, wherein the hash is a value that is smaller than the challenge; or the hash is a value that is greater than the challenge; or the hash is a value that is equal the challenge.

7. The method as claimed in claim 1, wherein the method includes:
hashing, by the processor, the generated solution with the randomized salt to generate the utilized solution generation time; and
determining, by the processor, if the utilized solution generation time is a time less than or equal to a time required for generating the challenge.

8. A method for avoiding a clock replication in a potential zombie electronic device, the method comprising:
transmitting, by a processor of a verification device, a challenge with a randomized salt to the potential zombie electronic device;
receiving, a processor of the potential zombie electronic device, the challenge;
triggering, by the received randomized salt and the received challenge, a processor of the potential zombie electronic device to run a clock time therein and ensure delay in the clock timing thereof;
hashing, by the processor of the potential zombie electronic device, the generated solution with the randomized salt to generate the utilized solution generation time;
generating, by the processor of the potential zombie electronic device, a solution to the received challenge and transmitting the solution to the verification device;
receiving, by the processor of the verification device, the generated solution, wherein the solution is generated in the form of a hash and by utilizing a solution generation time;
verifying, by the processor of the verification device, the solution by matching the hash and the utilized solution generation time with one or more pre-determined criterions associated with a difficulty level of the challenge; and
determining, by the processor of the verification device, the potential zombie electronic device being a zombie electronic device or not based on the verification.

9. The method as claimed in claim 1, wherein verifying the solution comprises of: determining, by the processor, if the utilized solution generation time is a time less than or equal to a time required for generating the challenge.

10. A verification device to avoid a clock replication in a potential zombie electronic device, the verification device comprising:
a processor configured to:
transmit a challenge with a randomized salt to the potential zombie electronic device, the challenge is a cryptographic challenge;
receive in response to the receipt of the challenge with the randomized salt, a solution generated by the potential zombie electronic device, wherein the solution is generated in the form of a hash and by utilizing a solution generation time, and wherein the solution is a preimage associated with the cryptographic challenge; and
verify the solution by matching the hash and the utilized solution generation time with one or more pre-determined criterions associated with a difficulty level of the challenge, wherein:
the hash is a value that is smaller than the challenge; or
the hash is a value that is greater than the challenge; or
the hash is a value that is equal the challenge; and
determine the potential zombie electronic device being a zombie electronic device or not based on the verification.

11. A system to avoid a clock replication in a potential zombie electronic device, the system comprising:
a verification device communicably coupled to the potential zombie electronic device, wherein the verification device having a processor configured to:
transmit a challenge with a randomized salt to the potential zombie electronic device;
receive, by a processor of the potential zombie electronic device, the challenge;
trigger, by the received randomized salt and the received challenge, a processor of the potential zombie electronic device to run a clock time therein and ensure delay in the clock timing thereof;
hash, by the processor of the potential zombie electronic device, the generated solution with the randomized salt to generate the utilized solution generation time;
generate, by the processor of the potential zombie electronic device, a solution to the received challenge and transmitting the solution to the verification device;
receive the generated solution, wherein the solution is generated in the form of a hash and by utilizing a solution generation time;
verify the solution by matching the hash and the utilized solution generation time with one or more pre-determined criterions associated with a difficulty level of the challenge; and
determine the potential zombie electronic device being a zombie electronic device or not based on the verification.
